(19) United States
(12) Patent Application Publication
(10) Pub. No.: US 2019/0156189 A1
(43) Pub. Date: May 23, 2019

(54) DEEP COGNITIVE NEURAL NETWORK (DCNN)

(71) Applicants: Newton Howard, Providence, RI (US); Ahsan Adeel, Providence, RI (US); Mandar Gogate, Providence, RI (US); Amir Hussain, Providence, RI (US)

(72) Inventors: Newton Howard, Providence, RI (US); Ahsan Adeel, Providence, RI (US); Mandar Gogate, Providence, RI (US); Amir Hussain, Providence, RI (US)

(21) Appl. No.: 16/194,721

(22) Filed: Nov. 19, 2018

Related U.S. Application Data
(60) Provisional application No. 62/588,210, filed on Nov. 17, 2017.

(51) Int. Cl. G06N 3/063; G06N 3/10

(52) U.S. Cl. CPC G06N 3/063; G06N 3/10

(57) ABSTRACT

Embodiments of the present systems and methods may provide a more efficient and low-powered cognitive computational platform utilizing a deep cognitive neural network (DCNN), incorporating an architecture that integrates convolutional feedforward and recurrent networks, and replaces multi-layer perceptron (MLP) based sigmoidal neural structures with a queuing theory-driven design. For example, in an embodiment, a circuit may comprise a plurality of layers of neural network circuitry, each layer comprising a plurality of neuron circuits, each neuron comprising a plurality of computational circuits, and each neuron connected to a plurality of other neurons in the same layer by synapse circuitry, wherein the plurality of layers of neural network circuitry are adapted to process symbolic and conceptual information.

### CROSS-REFERENCE TO RELATED APPLICATIONS

This application claims the benefit of U.S. Provisional Application No. 62/588,210, filed Nov. 17, 2018, the contents of which are incorporated herein in their entirety.

### BACKGROUND

The present invention relates to a cognitive computational platform utilizing a deep cognitive neural network (DCNN), incorporating an architecture that integrates convolutional feedforward and recurrent networks and a queuing theory-driven design.

Multi-layer perceptron (MLP) based deep neural networks (DNNs) have recently produced breakthroughs in a wide-range of Big Data problems such as speech and image recognition. However, high latency, computational cost, and power consumption are some of the bottlenecks to successful deployment of these systems in real-time. Currently, the implementation of most deep machine learning algorithms is based on digital computers utilizing a combination of CPUs and GPUs. For example, the DNN that recently won the ImageNet visual recognition challenge comprised more than 650,000 neurons and 60 million synapses requiring 2-6 Giga [billion] Operations per Second (GOPS) per classification. In conventional approaches, hardware-based neural network accelerators have attempted to realize MLP based shallow or deep neural networks only. However, MLP based DNNs are highly computationally complex with limited generalization capability, amenable to inefficient hardware/software implementations and extremely slow run-time calculations.

Accordingly, due to the growing computational cost and power consumption requirements for real-time analysis of Big Datasets, a need arises for more efficient and low-powered cognitive computational platforms.

### SUMMARY

Embodiments of the present systems and methods may provide a more efficient and low-powered cognitive computational platform utilizing a deep cognitive neural network (DCNN), incorporating an architecture that integrates convolutional feedforward and recurrent networks, and replaces multi-layer perceptron (MLP) based sigmoidal neural structures with a queuing theory-driven design.

For example, in an embodiment, a circuit may comprise a plurality of layers of neural network circuitry, each layer comprising a plurality of neuron circuits, each neuron comprising a plurality of computational circuits, and each neuron connected to a plurality of other neurons in the same layer by synapse circuitry, wherein the plurality of layers of neural network circuitry are adapted to process symbolic and conceptual information.

In an embodiment, a system may comprise a processor, memory accessible by the processor, and computer program instructions stored in the memory and executable by the processor to implement a plurality of layers of neural network computation elements, each layer comprising a plurality of neuron computation elements, each neuron comprising a plurality of computational elements, and each neuron connected to a plurality of other neurons in the same layer by synapse computation elements, wherein the plurality of layers of neural network circuitry are adapted to process symbolic and conceptual information.

In an embodiment, a computer program product may comprise a non-transitory computer readable storage having program instructions embodied therewith, the program instructions executable by a computer, to cause the computer to implement a plurality of layers of neural network computation elements, each layer comprising a plurality of neuron computation elements, each neuron comprising a plurality of computational elements, and each neuron connected to a plurality of other neurons in the same layer by synapse computation elements, wherein the plurality of layers of neural network circuitry are adapted to process symbolic and conceptual information.

### BRIEF DESCRIPTION OF THE DRAWINGS

The details of the present invention, both as to its structure and operation, can best be understood by referring to the accompanying drawings, in which like reference numbers and designations refer to like elements.

FIG. 1 illustrates an exemplary system in which the embodiments of the present systems and methods may be implemented.

FIG. 2 is a block diagram of neuronal computing circuitry and synapse, according to embodiments of the present systems and methods.

FIG. 3 is an exemplary block diagram of a computer system in which processes involved in the embodiments described herein may be implemented.

### DETAILED DESCRIPTION

Embodiments of the present systems and methods may provide a more efficient and low-powered cognitive computational platform utilizing a deep cognitive neural network (DCNN), incorporating an architecture that integrates convolutional feedforward and recurrent networks, and replaces multi-layer perceptron (MLP) based sigmoidal neural structures with a queuing theory-driven design.

Embodiments may provide highly energy-efficient implementation, fast decision-making, and excellent generalization (long-term learning). Embodiments may be highly energy-efficient in computing with low energy requirements that may be implemented in both hardware and software, as its neurons may be represented by simple equations consisting of addition, subtraction, and division operations. For example, embodiments may include a highly energy-efficient implementation of shallow neural networks using complementary metal-oxide semiconductor (CMOS) or Probabilistic CMOS (PCMOS) technology, which may be significantly more efficient in terms of energy performance product (EPP), over microprocessors and conventional CMOS implementations.

The substantial gain per-operation may be proportional and dependent on the entire application, where large gains are expected with deep structures for large scale processing. Embodiments of the present DCNN may provide faster decision-making as compared to a conventional deep neural network comprising. Similarly, embodiments may provide a comparative generalization improvement in extreme environmental changes without the need of retraining. Embodiments of the present DCNN may provide quick convergence behavior when integrated with reasoning algorithms to acquire human-like computing (both perception and reasoning simultaneously) in real-time. Further, embodiments may provide low power and energy efficient devices capable of handling massive arrays of mathematical calculations in real-time for both generalized learning and optimization applications.

Conventional DNN processing units emulate neuromorphic system using digital arithmetic units and Boolean gates, which are inherently a mismatch with the realization of neurons and synapses. Embodiments of the present DCNN may include a next-generation architecture which exploits the inherent efficiency of DCNN for large-scale neuromorphic computing. Embodiments of the present DCNN may include brain-inspired clock free (event-driven) neural circuitry to gain efficient computational benefits.

A deep neural network (DNN) is an artificial neural network (ANN) with multiple layers between the input and output layers. A multilayer perceptron (MLP) is a class of feedforward artificial neural network. An MLP consists of, at least, three layers of nodes: an input layer, a hidden layer and an output layer. Cognitive computing is a type of computing that attempts reasoning and understanding at a higher level, and may be based on or inspired by human cognition. A cognitive neural network is a neural network that may be trained on and may handle symbolic and conceptual information rather than just pure data or sensor streams. A DCNN them may be a deep neural network that may handle symbolic and conceptual information and may attempt to make high-level decisions in complex situations.

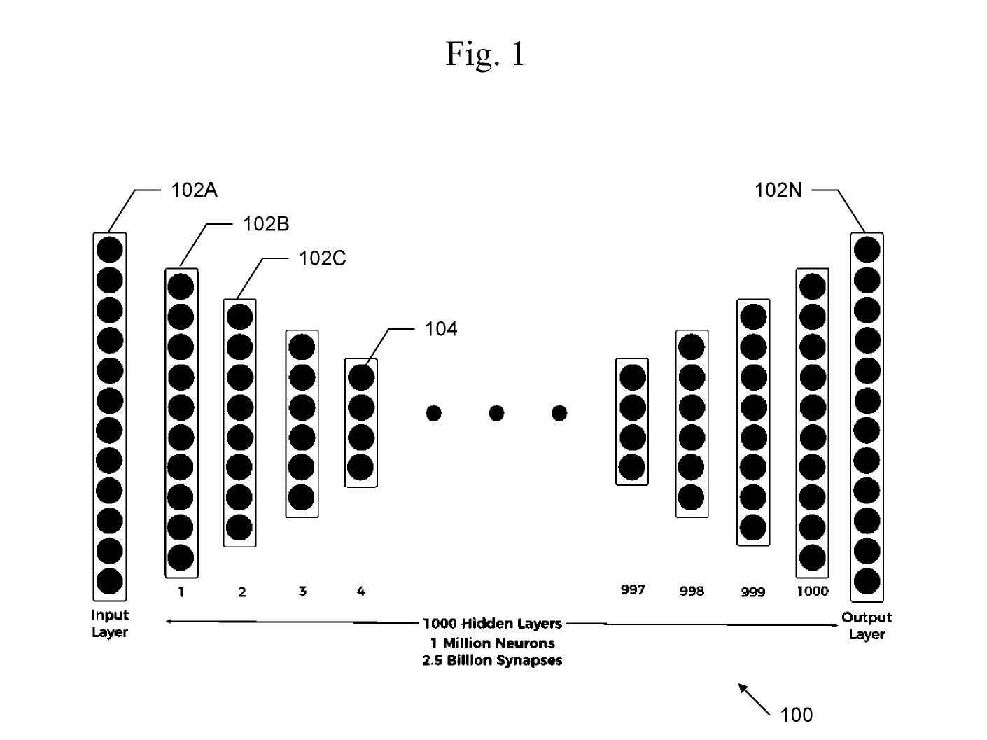

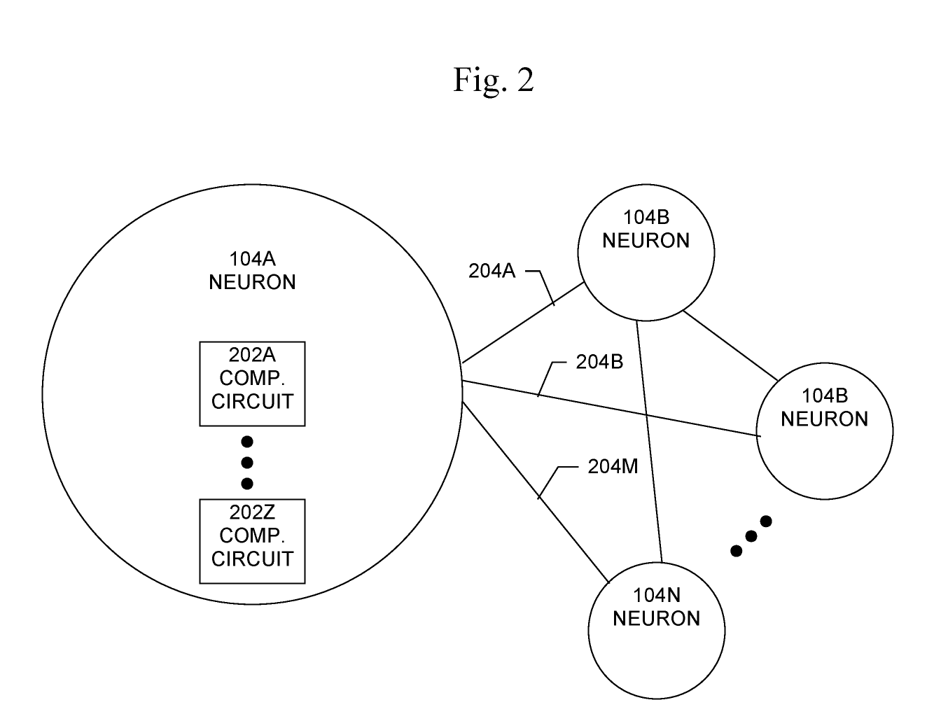

An exemplary DCNN 100 in which embodiments of the present systems and methods may be implemented is shown in FIG. 1. In this example, DCNN 100 may include a plurality of hidden layers 102A-N, with each layer including a plurality of neurons, such as neuron 104. As shown in FIG. 2, each neuron may include a plurality of computational circuits, such as computational circuits 202A-Z. Each neuron, such as neuron 104A may be connected to a plurality of other neurons, such as neurons 104B-N, by a plurality of synapses, such as synapses 204A-M. In this example, DCNN 100 may include one million neurons and 2.5 billion synapses.

The future of big data analytics is likely to demand more power and processing hungry platforms for running real-time applications, such as virtual and augmented reality, hyperspectral imaging, IoT etc. In contrast, our proposed DCNN exhibits a highly energy-efficient computational implementation with significantly enhanced generalization capability and real-time human-like decision-making capabilities. Embodiments of the present DCNN may provide tens of millions of neurons and billions of synapses running in near real-time, on small devices such as mobile phones and next-generation IoT systems.

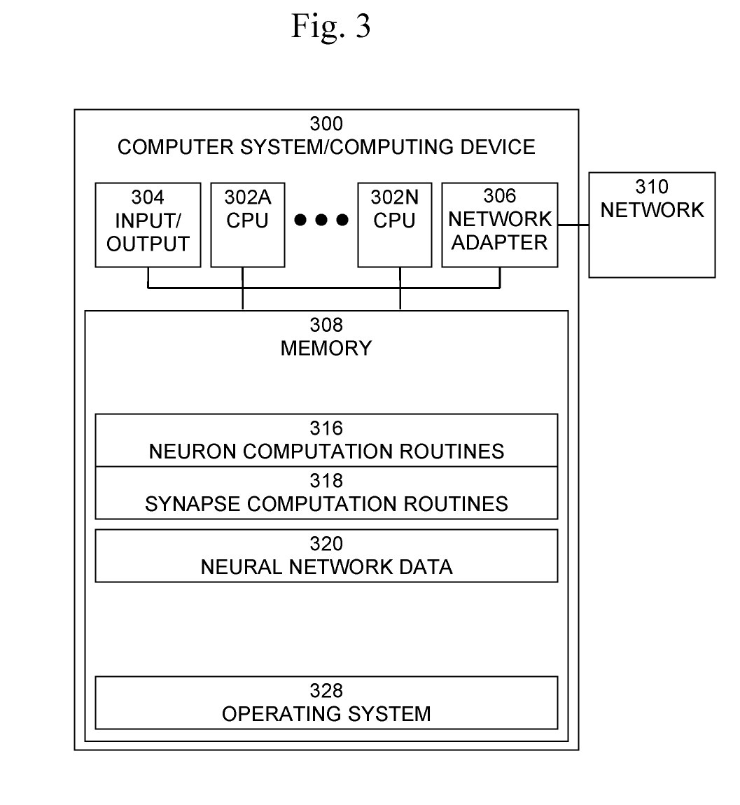

An exemplary block diagram of a computer system 302, in which processes involved in the embodiments described herein may be implemented, is shown in FIG. 3. Computer system 302 may be implemented using one or more programmed general-purpose computer systems, such as embedded processors, systems on a chip, personal computers, workstations, server systems, and minicomputers or mainframe computers, mobile devices, such as smartphones or tablets, or in distributed, networked computing environments. Computer system 302 may include one or more processors (CPUs) 302A-302N, input/output circuitry 304, network adapter 306, and memory 308. CPUs 302A-302N execute program instructions in order to carry out the functions of the present communications systems and methods. Typically, CPUs 302A-302N are one or more microprocessors, such as an INTEL CORE® processor or an ARM® processor. FIG. 3 illustrates an embodiment in which computer system 302 is implemented as a single multi-processor computer system, in which multiple processors 302A-302N share system resources, such as memory 308, input/output circuitry 304, and network adapter 306. However, the present communications systems and methods also include embodiments in which computer system 302 is implemented as a plurality of networked computer systems, which may be single-processor computer systems, multi-processor computer systems, or a mix thereof.

Input/output circuitry 304 provides the capability to input data to, or output data from, computer system 302. For example, input/output circuitry may include input devices, such as keyboards, mice, touchpads, trackballs, scanners, analog to digital converters, etc., output devices, such as video adapters, monitors, printers, biometric information acquisition devices, etc., and input/output devices, such as, modems, etc. Network adapter 306 interfaces device 300 with a network 310. Network 310 may be any public or proprietary LAN or WAN, including, but not limited to the Internet.

Memory 308 stores program instructions that are executed by, and data that are used and processed by, CPU 302 to perform the functions of computer system 302. Memory 308 may include, for example, electronic memory devices, such as random-access memory (RAM), read-only memory (ROM), programmable read-only memory (PROM), electrically erasable programmable read-only memory (EEPROM), flash memory, etc., and electro-mechanical memory, such as magnetic disk drives, tape drives, optical disk drives, etc., which may use an integrated drive electronics (IDE) interface, or a variation or enhancement thereof, such as enhanced IDE (EIDE) or ultra-direct memory access (UDMA), or a small computer system interface (SCSI) based interface, or a variation or enhancement thereof, such as fast-SCSI, wide-SCSI, fast and wide-SCSI, etc., or Serial Advanced Technology Attachment (SATA), or a variation or enhancement thereof, or a fiber channel-arbitrated loop (FC-AL) interface.

The contents of memory 308 may vary depending upon the function that computer system 302 is programmed to perform. In the example shown in FIG. 3, exemplary memory contents are shown representing routines and data for embodiments of the processes described above. However, one of skill in the art would recognize that these routines, along with the memory contents related to those routines, may not be included on one system or device, but rather may be distributed among a plurality of systems or devices, based on well-known engineering considerations. The present communications systems and methods may include any and all such arrangements.

In the example shown in FIG. 3, computer system 300 may include neuron computation routines 316, synapse computation routines 318, and neural network data 320. Neuron computation routines 316 may include software routines to perform neuron computation processes, as described above. Synapse computation routines 318 may include software routines to perform synapse computation processes, as described above. Neural network data 320 may include data representing trained neural networks, as described above. Operating system 322 may provide overall system functionality.

As shown in FIG. 3, the present communications systems and methods may include implementation on a system or systems that provide multi-processor, multi-tasking, multi-process, and/or multi-thread computing, as well as implementation on systems that provide only single processor, single thread computing. Multi-processor computing involves performing computing using more than one processor. Multi-tasking computing involves performing computing using more than one operating system task. A task is an operating system concept that refers to the combination of a program being executed and bookkeeping information used by the operating system. Whenever a program is executed, the operating system creates a new task for it. The task is like an envelope for the program in that it identifies the program with a task number and attaches other bookkeeping information to it. Many operating systems, including Linux, UNIX®, OS/2®, and Windows®, are capable of running many tasks at the same time and are called multitasking operating systems. Multi-tasking is the ability of an operating system to execute more than one executable at the same time. Each executable is running in its own address space, meaning that the executables have no way to share any of their memory. This has advantages, because it is impossible for any program to damage the execution of any of the other programs running on the system. However, the programs have no way to exchange any information except through the operating system (or by reading files stored on the file system). Multi-process computing is similar to multi-tasking computing, as the terms task and process are often used interchangeably, although some operating systems make a distinction between the two.

The present invention may be a system, a method, and/or a computer program product at any possible technical detail level of integration. The computer program product may include a computer readable storage medium (or media) having computer readable program instructions thereon for causing a processor to carry out aspects of the present invention. The computer readable storage medium can be a tangible device that can retain and store instructions for use by an instruction execution device.

The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers, and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Although specific embodiments of the present invention have been described, it will be understood by those of skill in the art that there are other embodiments that are equivalent to the described embodiments. Accordingly, it is to be understood that the invention is not to be limited by the specific illustrated embodiments, but only by the scope of the appended claims.

What is claimed is:

1. A circuit comprising:
a plurality of layers of neural network circuitry, each layer comprising a plurality of neuron circuits, each neuron comprising a plurality of computational circuits, and each neuron connected to a plurality of other neurons in the same layer by synapse circuitry, wherein the plurality of layers of neural network circuitry are adapted to process symbolic and conceptual information.

2. A system comprising a processor, memory accessible by the processor, and computer program instructions stored in the memory and executable by the processor to implement:
a plurality of layers of neural network computation elements, each layer comprising a plurality of neuron computation elements, each neuron comprising a plurality of computational elements, and each neuron connected to a plurality of other neurons in the same layer by synapse computation elements, wherein the plurality of layers of neural network circuitry are adapted to process symbolic and conceptual information.

3. A computer program product comprising a non-transitory computer readable storage having program instructions embodied therewith, the program instructions executable by a computer, to cause the computer to implement:
a plurality of layers of neural network computation elements, each layer comprising a plurality of neuron computation elements, each neuron comprising a plurality of computational elements, and each neuron connected to a plurality of other neurons in the same layer by synapse computation elements, wherein the plurality of layers of neural network circuitry are adapted to process symbolic and conceptual information.
